(19) United States
(12) Patent Application Publication
(10) Pub. No.: US 2019/0377151 A1
(43) Pub. Date: Dec. 12, 2019

(54) OPTICAL DEVICE AND A METHOD FOR MANUFACTURING THE SAME

(71) Applicant: Tong Hsing Electronic Industries, Ltd., Taipei City (TW)

(72) Inventors: Shao-Pin RU, Taipei City (TW); Chia-Yi CHANG, Taipei City (TW); Zzu-Chi CHIU, Taipei City (TW)

(21) Appl. No.: 16/436,639

(22) Filed: Jun. 10, 2019

(30) Foreign Application Priority Data
Jun. 12, 2018 (TW) 107120204

(51) Int. Cl. G02B 7/02

(52) U.S. Cl. CPC G02B 7/025; G02B 7/028

(57) ABSTRACT

An optical device includes an optical module, a lens, and a first adhesive member. The optical module includes a base seat, a frame member that defines a hollow region and that has a top surface, and an optical element that is connected to the base seat and that is received in the hollow region. The lens has a first surface that faces the base seat and the optical element, and that is connected to the frame member to cover the hollow region, a second surface that is opposite to the first surface, and a side surface that interconnects the first and second surfaces. The first adhesive member is connected to the side surface of the lens and the top surface of the frame member. A method for manufacturing optical devices is also disclosed.

### CROSS-REFERENCE TO RELATED APPLICATION

This application claims priority of Taiwanese Invention Patent Application No. 107120204, filed on Jun. 12, 2018.

### FIELD

The disclosure relates to an optical device, more particularly to an optical device with an increased area for adhesive contact between a frame member and a lens, and a method for manufacturing such optical devices.

### BACKGROUND

Referring to FIG. 1, a conventional optical device 9 includes an optical module 91, an adhesive member 92 and a lens 93. The optical module 91 includes a base seat 911, an optical element 912 connected to the base seat 911, and a frame member 913 that is disposed on the base seat 911 and that defines a hollow region 914 for receiving the optical element 912. The frame member 913 has a top surface which is partially indented to form a notched portion 915 in spatial communication with the hollow region 914. During production, the lens 93 is received in the hollow region 914 and the notched portion 915 in a position above the optical member 912, and is secured to the optical module 91 by the adhesive member 92, which is disposed in the notched portion 915 and interposed between the lens 93 and the indented top surface of the frame member 913. The lens 93 has a lower surface 931 that is proximate to the base seat 911 and that is peripherally pressed against the adhesive member 92 so as to be secured to the frame member 913 by the adhesive member 92. The lens 93 acts as a protective cover over the optical element 912 while allowing light emitted by the optical element 912 to transmit out of the conventional optical device 9.

However, as a surface area of contact between the frame member 913 and the lens 93 is relatively small, in practical use the lens 93 may easily be dislodged from the frame member 913 due to collisions or vibrations and be rendered non-functional.

Due to the optical element 912 having high power, much heat has to be dissipated during operation thereof. For this reason, the base seat 911 is generally made from a ceramic material characterized by high heat dissipation efficiency. However, if the frame member 913 disposed on the base seat 911 is made from a material having a thermal expansion coefficient not well matched with that of the ceramic material of the base seat 911, e.g. a conventional liquid-crystal polymer (LCP), the frame member 913 may warp and affect the reliability of the optical device when the frame member 913 has a much larger area and is secured to the base seat 911 using hot curing. As such, if this kind of material is used, the optical devices must be made individually for obtaining the required yield, which increases the cost and time of manufacture.

### SUMMARY

Therefore, an object of the disclosure is to provide an optical device that can alleviate some of the drawbacks of the prior art. A method of producing the optical device is also provided.

According to one aspect of the disclosure, an optical device includes an optical module, a lens, and a first adhesive member.

The optical module includes a base seat, a frame member that has a bottom surface connected to the base seat and a top surface opposite to the bottom surface and that defines a hollow region, and an optical element that is connected to the base seat and that is received in the hollow region.

The lens has a first surface that faces the base seat and the optical element and that is connected to the frame member to cover the hollow region, a second surface that is opposite to the first surface, and a side surface that interconnects the first and second surfaces.

The first adhesive member is connected to the side surface of the lens and the top surface of the frame member.

According to another aspect of the disclosure, a method for manufacturing optical devices includes:

(A) connecting a frame unit defining a plurality of hollow regions to a base seat unit;

(B) connecting a plurality of optical elements to the base seat unit;

(C) connecting a plurality of spaced-apart lenses to the frame unit to respectively cover the hollow regions, and forming a gap among the lenses, each of the lenses having a first surface that faces the base seat unit and a respective one of the optical elements, a second surface opposite to the first surface and a side surface interconnecting the first and second surfaces of the lens;

(D) filling a first adhesive layer into the gap among the lenses, the first adhesive layer being connected to the side surfaces of the lenses and the frame unit and defined with a plurality of intersecting scribing lines which define boundaries of the optical devices; and

(E) dicing the first adhesive layer, the frame unit and the base seat unit along the scribing lines.

### BRIEF DESCRIPTION OF THE DRAWINGS

Other features and advantages of the disclosure will become apparent in the following detailed description of the embodiments with reference to the accompanying drawings, of which:

FIG. 1 is a sectional view of a conventional optical device;

FIG. 2 is a sectional view of an embodiment of an optical device according to the disclosure;

FIG. 3 is a flow chart illustrating consecutive steps of an embodiment of a method of manufacturing an optical device according to the disclosure;

FIGS. 4 to 10 are schematic views illustrating the consecutive steps of the embodiment of the method of FIG. 3; and

FIG. 11 is a sectional view of another configuration of the embodiment of the optical device.

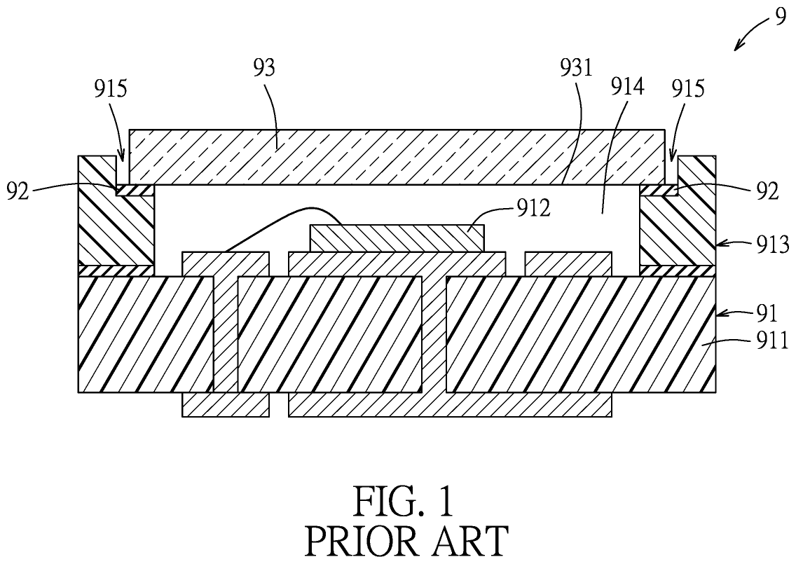

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

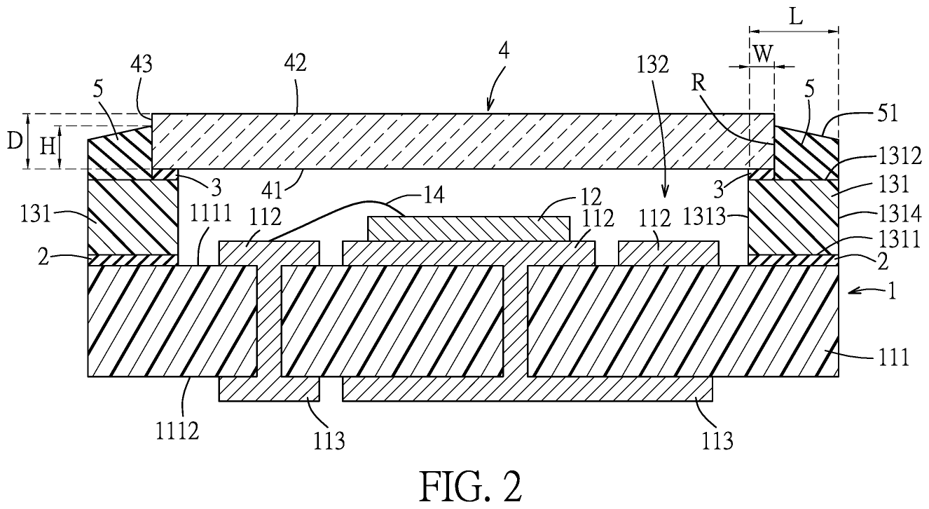

Referring to FIG. 2, an embodiment of an optical device according to the disclosure includes an optical module 1, a lens 4, a first adhesive member 5, a second adhesive member 2, and a third adhesive member 3. The embodiment of the optical device may be utilized in the technical field of 3-D image recognition, for example, the 3-D image recognition involving a Vertical-Cavity Surface-Emitting Laser (VCSEL).

The optical module 1 includes a base seat 111, a frame member 131, and an optical element 12. The base seat 111 has a top surface 1111 and a bottom surface 1112 opposite to the top surface 1111. The frame member 131 has a bottom surface 1311 connected to the top surface 1111 of the base seat 111 and a top surface 1312 opposite to the bottom surface 1311 and defines a hollow region 132. The optical element 12 is connected to the top surface 1111 of the base seat 111 and is received in the hollow region 132.

The optical module 1 further includes a first circuit pattern 112 formed on the top surface 1111 of the base seat 111 and a second circuit pattern 113 formed on the bottom surface 1112 of the base seat 111. The first circuit pattern 112 and the second circuit pattern 113 are connected with each other via electrical conductive material-filled through holes extending through the base seat 111 and connected therebetween.

In this embodiment, the base seat 111 is made of a ceramic material that has a high thermal conductivity, a low warpage, a low thermal expansion coefficient, etc. The ceramic material may be selected from the group consisting of aluminum oxide, aluminum nitride, silicon nitride, zirconium oxide, zirconia-toughened aluminum oxide, beryllium oxide, and combinations thereof. In particular, the thermal expansion coefficient of aluminum oxide is 8×10⁻⁶/° C., and the thermal expansion coefficient of aluminum nitride is 5.0×10⁻⁶/° C.

In this embodiment, the hollow region 132 may have a tetragonal cross section. Selection of a material used for making the frame member 131 is determined based on the ceramic material for making the base seat 111. Specifically, the frame member 131 may have a thermal expansivity substantially equal to that of the base seat 111. The material for making the frame member 131 may be similarly selected from the group consisting of aluminum oxide, aluminum nitride, silicon nitride, zirconium oxide, zirconia-toughened aluminum oxide, beryllium oxide, and combinations thereof. Hence, warping of the frame member 131 occurring during high temperature production of the optical device or during use due to mismatch between the thermal expansion coefficients of the frame member 131 and the base seat 111 is reduced.

The frame member 131 has an inner surface 1313 surrounding the hollow region 132 and an outer surface 1314 opposite to the inner surface 1313. Each of the inner and outer surfaces 1313, 1314 extends from the bottom surface 1311 to the top surface 1312.

The second adhesive member 2 is electrically insulative and is connected between the frame member 131 and the base seat 111. The second adhesive member 2 may include cerium oxide and trimethoxysilyl.

The third adhesive member 3 is connected between the lens 4 and the frame member 131 and may be made from a thermosetting material, such as a thermosetting synthetic resin.

The lens 4 has a first surface 41 that faces the top surface 1111 of the base seat 111 and the optical element 12 and that is connected to the frame member 131 to cover the hollow region 132, a second surface 42 that is opposite to the first surface 41, and a side surface 43 that interconnects the first and second surfaces 41, 42. The lens 4 has a longitudinal cross section coplanar with the inner surface 1313 of the frame member 131. A distance between the longitudinal cross section and the side surface 43 of the lens 4 is less than a distance (L) between the inner and outer surfaces 1313, 1314 of the frame member 131. In this embodiment, the distance between the longitudinal cross section and the side surface 43 of the lens 4 is less than ⅓ of the distance (L) between the inner and outer surfaces 1313, 1314 of the frame member 131. In one form, the lens 4 is substantially tetragonal. The lens 4 may be made of glass.

The first adhesive member 5 is connected to the side surface 43 of the lens 4 and the top surface 1312 of the frame member 131. The first adhesive member 5 has a transverse cross section coplanar with the first surface 41 of the lens 4 and a contact region (R) attached to the side surface 43 of the lens 4. A height (H) of the contact region (R) of the first adhesive member 5 measured from the transverse cross section ranges from ½ to ⅔ of a distance (D) between the first and second surfaces 41, 42 of the lens 4. In certain embodiments, the height (H) of the contact region (R) of the first adhesive member 5 is greater than ½ of the distance (D) between the first and second surfaces 41, 42 of the lens 4. In one form, the first adhesive member 5 has a top surface 51 opposite to the top surface 1312 of the frame member 131 and lower than the second surface 42 of the lens 4.

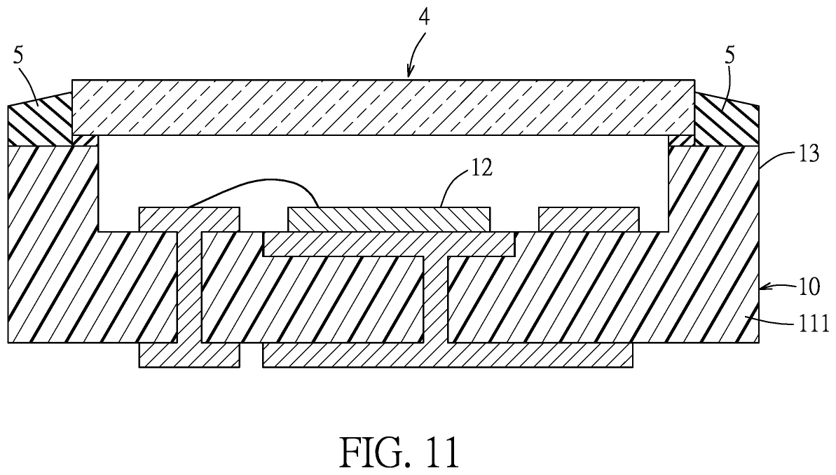

Referring to FIG. 11, another configuration of the embodiment of the optical device according to the disclosure is illustrated. In this configuration, the differences are that the base seat 111 and the frame member 131 are made of the same material and are integrally formed as one piece.

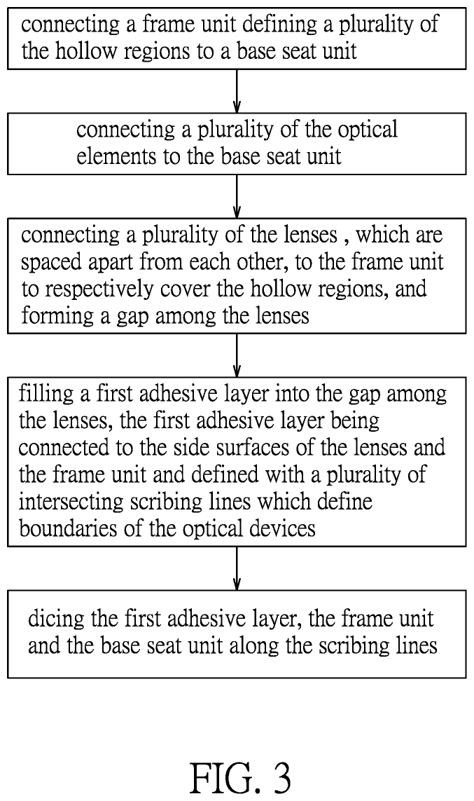

Referring to FIG. 3, an embodiment of a method of manufacturing a plurality of the abovementioned optical devices according to this disclosure is illustrated. The method includes:

(A) connecting a frame unit 13 defining a plurality of the hollow regions 132 to a base seat unit 11;

(B) connecting a plurality of the optical elements 12 to the base seat unit 11;

(C) connecting a plurality of the lenses 4, which are spaced apart from each other, to the frame unit 13 to respectively cover the hollow regions 132, and forming a gap 44 among the lenses 4;

(D) filling a first adhesive layer 5′ into the gap 44 among the lenses 4, the first adhesive layer 5′ being connected to the side surfaces 43 of the lenses 4 and the frame unit 13 and defined with a plurality of intersecting scribing lines which define boundaries of the optical devices; and

(E) dicing the first adhesive layer 5′, the frame unit 13 and the base seat unit 11 along the scribing lines.

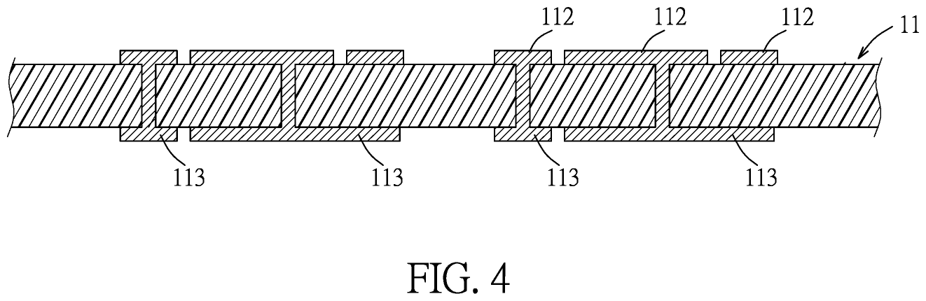

Referring to FIG. 4, before step (A), the base seat unit 11 is formed with multiple sets of the first and second circuit patterns 112, 113 on top and bottom surfaces of the base seat unit 11 and the electrical conductive material-filled through holes that extend through the base seat unit 11 and connected between the first and second circuit patterns 112, 113. The multiple sets of the first and second circuit patterns 112, 113 and the electrical conductive material-filled through holes may be formed by laser perforation, electroplating, etching, etc.

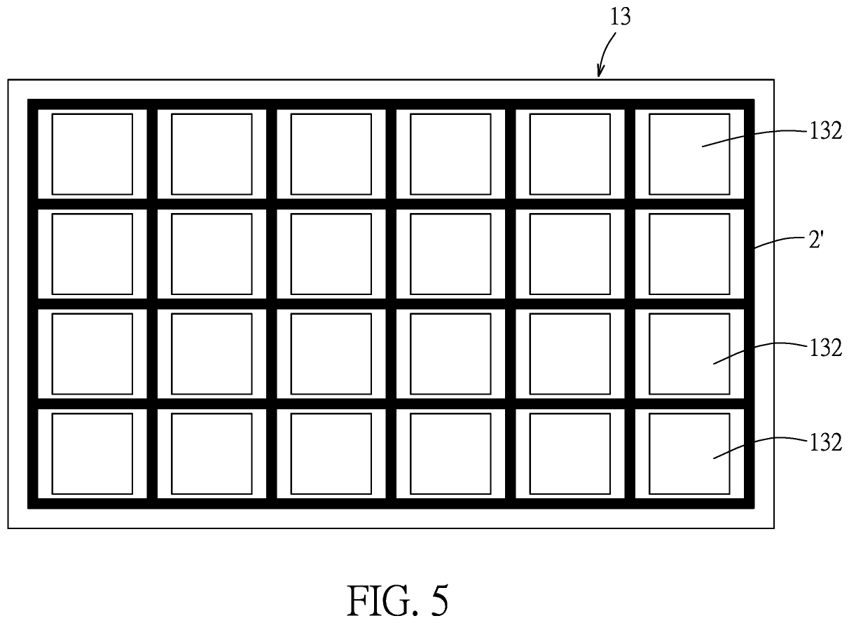

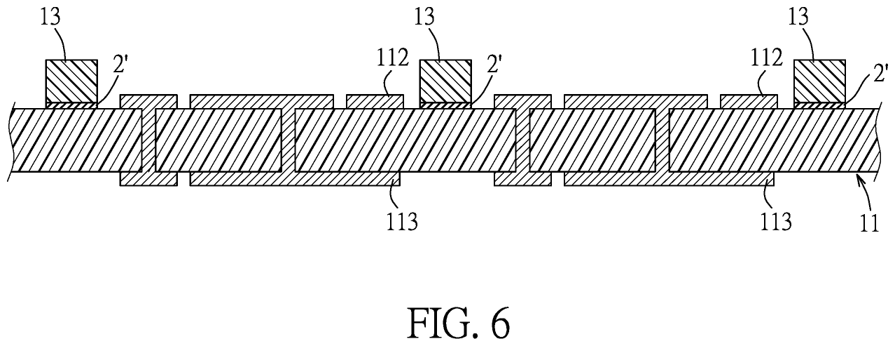

Referring to FIGS. 5 and 6, the definition of the hollow regions 132 that are spaced apart from each other may be conducted by laser cutting. In one form, in step (A), the connection of the frame unit 13 to the base seat unit 11 is conducted by applying a second adhesive layer 2′ between the frame unit 13 and the base seat unit 11, such as by printing, followed by curing the second adhesive layer 2′. In this embodiment, since the thermal expansivity of the frame unit 13 and the base seat unit 11 are substantially equal, in the high temperature conditions of the curing process, warping of the frame unit 13 can be avoided. Furthermore, by using the frame unit 13 and the base seat unit 11 in production, a plurality of the optical devices are made in one production, shortening the overall production time.

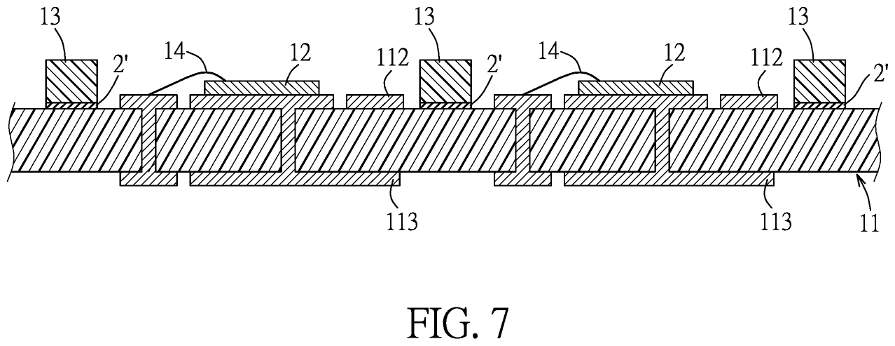

Referring to FIG. 7, in step (B), a plurality of the optical elements 12 are connected to the base seat unit 11. Each of the optical elements 12 corresponds in position to and is secured in a respective one of the hollow regions 132. Each of the optical elements 12 is then electrically connected via wires 14 (only one is shown) to the first circuit pattern 112 in the respective one of the hollow regions 132 by wire bonding, such that the optical elements 12 may be driven to emit light. By connecting the base seat unit 11 to the frame unit 13 before the optical elements 12, the ease of installing the optical elements 12 precisely in position on each optical device is increased. However, steps (A) and (B) are not limited to this order. In another embodiment, step (B) may be performed before step (A).

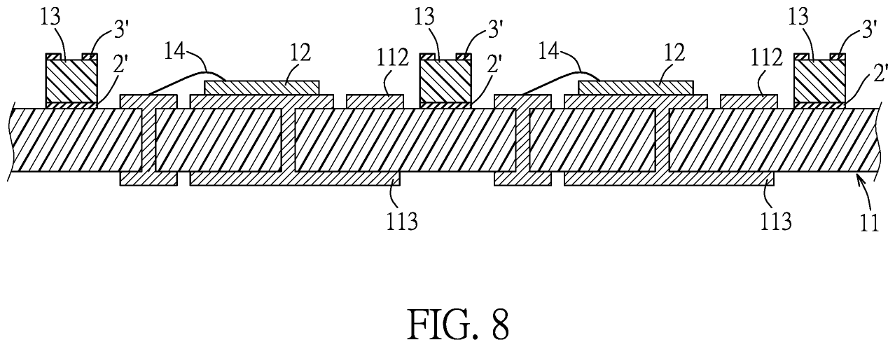

Referring to FIG. 8, in step (C), an adhesive dispensing process is performed where a third adhesive layer 3′ is applied to the frame unit 13.

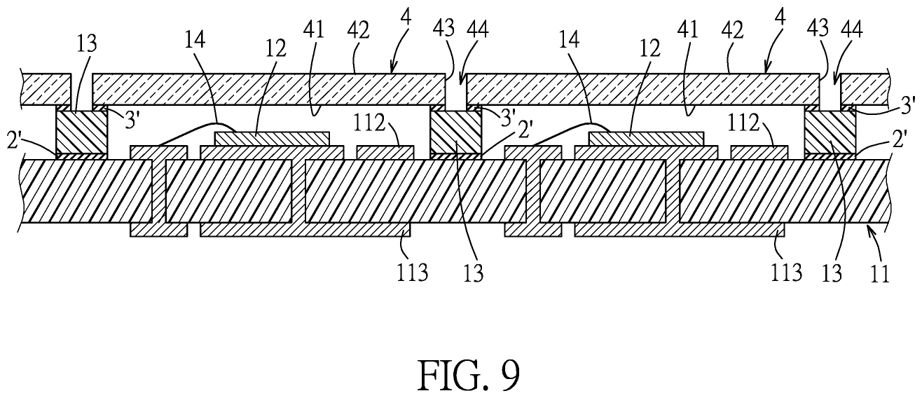

Referring to FIG. 9, further in step (C), a plurality of spaced-apart lenses 4 are connected to the frame unit 13 through the third adhesive layer 3′ to respectively cover the hollow regions 132 and to form the gap 44 among the lenses 4 that is free of the third adhesive layer 3′. Each of the lenses 4 has the first surface 41 that faces the base seat unit 11 and a respective one of the optical elements 12, the second surface 42 opposite to the first surface 41, and the side surface 43 interconnecting the first and second surfaces 41, 42 of the lens 4.

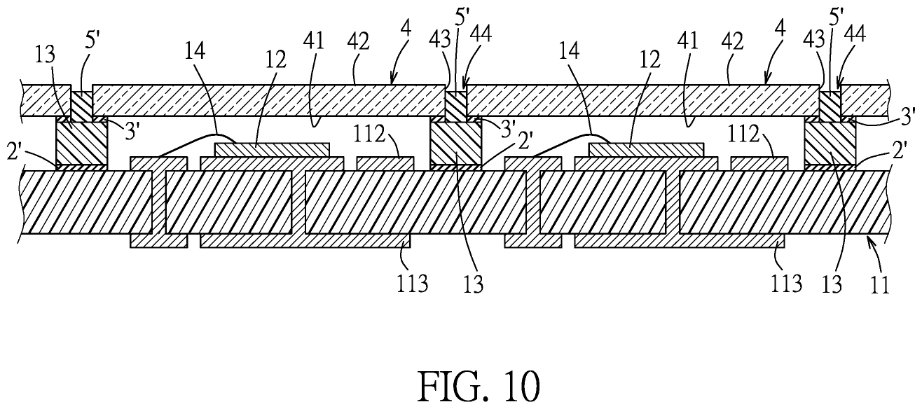

Referring to FIG. 10, in step (D), a first adhesive layer 5′ is filled into the gap 44 among the lenses 4. The first adhesive layer 5′ is connected to the side surfaces 43 of the lenses 4 and the frame unit 13 and defined with a plurality of intersecting scribing lines which define boundaries of the optical devices. In this embodiment, the first adhesive layer 5′ has a maximum height (H) that is measured from a plane defined by the first surfaces 41 of the lenses 4 and that ranges from ½ to ⅔ of a distance (D) between the first and second surfaces 41, 42 of each of the lenses 4.

Referring to FIG. 2, in step (E), the first adhesive layer 5′, the frame unit 13 and the base seat unit 11 are diced along the scribing lines, so as to form the optical devices, each including the first adhesive member 5 formed from dicing the first adhesive layer 5′.

In sum, by virtue of connecting the first adhesive layer 5′ to the side surfaces 43 of the lenses 4 and the frame unit 13 by filling the first adhesive layer 5′ into the gap 44 after the plurality of lenses are connected to the frame unit 13 by the third adhesive layer 3′, the surface area of contact between the first adhesive layer 5′ and the lenses 4 is increased. Hence, the bonding strength between the lenses 4 and the frame unit 13 is increased, lowering the risks of the lenses 4 being dislodged. Furthermore, by making the frame unit 13 and the base seat unit 11 out of the same ceramic material, and thus the frame member 131 and the base seat 111 out of the same material, the frame member 131 and the base seat 111 would have equal thermal expansivities, thus reducing warping of the frame member 131 during high temperature curing or during reliability tests, and allow the use of the frame unit 13 and the base seat unit 11 to produce a plurality of the optical devices simultaneously, improving the efficiency of production.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An optical device comprising:
an optical module including
a base seat,
a frame member that has a bottom surface connected to said base seat and a top surface opposite to said bottom surface, and that defines a hollow region, and
an optical element that is connected to said base seat and that is received in said hollow region;
a lens having
a first surface that faces said base seat and said optical element, and that is connected to said frame member to cover said hollow region,
a second surface that is opposite to said first surface, and
a side surface that interconnects said first and second surfaces; and
a first adhesive member that is connected to said side surface of said lens and said top surface of said frame member.

2. The optical device as claimed in claim 1, wherein said first adhesive member has a transverse cross section coplanar with said first surface of said lens and a contact region attached to said side surface of said lens, a height of said contact region of said first adhesive member measured from said transverse cross section being greater than ½ of a distance between said first and second surfaces of said lens.

3. The optical device as claimed in claim 2, wherein the height of said contact region of said first adhesive member ranges from ½ to ⅔ of the distance between said first and second surfaces of said lens.

4. The optical device as claimed in claim 1, wherein said frame member has a thermal expansivity substantially equal to that of said base seat.

5. The optical device as claimed in claim 4, wherein said frame member and said base seat are independently made from a ceramic material selected from the group consisting of aluminum oxide, aluminum nitride, silicon nitride, zirconium oxide, zirconia-toughened aluminum oxide, beryllium oxide, and combinations thereof.

6. The optical device as claimed in claim 1, further comprising a second adhesive member that is electrically insulative and that is connected between said frame member and said base seat.

7. The optical device as claimed in claim 1, further comprising a third adhesive member that is made from a thermosetting material and that is connected between said lens and said frame member.

8. The optical device as claimed in claim 1, said frame member has an inner surface surrounding said hollow region and an outer surface opposite to said inner surface, each of said inner and outer surfaces extending from said bottom surface to said top surface, said lens having a longitudinal cross section coplanar with said inner surface of said frame member, a distance between said longitudinal cross section and said side surface of said lens being less than a distance between said inner and outer surfaces of said frame member.

9. The optical device as claimed in claim 1, wherein said first adhesive member has a top surface opposite to said top surface of said frame member and lower than said second surface of said lens.

10. The optical device as claimed in claim 1, wherein said base seat and said frame member are made of the same material and are integrally formed as one piece.

11. A method for manufacturing optical devices, comprising:
(A) connecting a frame unit defining a plurality of hollow regions to a base seat unit;
(B) connecting a plurality of optical elements to the base seat unit;
(C) connecting a plurality of spaced-apart lenses to the frame unit to respectively cover the hollow regions, and forming a gap among the lenses, each of the lenses having a first surface that faces the base seat unit and a respective one of the optical elements, a second surface opposite to the first surface and a side surface interconnecting the first and second surfaces of the lens;
(D) filling a first adhesive layer into the gap among the lenses, the first adhesive layer being connected to the side surfaces of the lenses and the frame unit and defined with a plurality of intersecting scribing lines which define boundaries of the optical devices; and
(E) dicing the first adhesive layer, the frame unit and the base seat unit along the scribing lines.

12. The method as claimed in claim 11, wherein the connection of the frame unit to the base seat unit is conducted by applying a second adhesive layer between the frame unit and the base seat unit, and curing the second adhesive layer.

13. The method as claimed in claim 11, wherein after step (A), the connection of the optical elements to the base seat unit is conducted by securing each of the optical elements in a respective one of the hollow regions.

14. The method as claimed in claim 11, wherein, in step (C), the lenses are connected to the frame unit through an adhesive dispensing process.

15. The method as claimed in claim 11, wherein said first adhesive layer has a maximum height that is measured from a plane defined by said first surfaces of said lenses and that ranges from ½ to ⅔ of a distance between said first and second surfaces of each of said lenses.
